(19) United States
(12) Patent Application Publication
(10) Pub. No.: US 2019/0059437 A1
(43) Pub. Date: Feb. 28, 2019

(54) TUMBLE DRUM ADAPTED FOR RECOVERY AND SUPPRESSION OF AIRBORNE FLAVORING MATERIAL AND METHOD

(71) Applicant: Heat & Control, Inc., Flower Mound, TX (US)

(72) Inventors: Paul Blake Svejkovsky, Coppell, TX (US); Jason Lee Danner, Lantana, TX (US)

(21) Appl. No.: 15/683,579

(22) Filed: Aug. 22, 2017

(51) Int. Cl. A23P 20/13

(52) U.S. Cl. CPC A23P 20/13

(57) ABSTRACT

A tumble drum for recovering at least some flavoring material dispensed onto food portions processed within the tumble drum, the tumble drum having an interior mixing chamber, a first set of apertures in a wall of the tumble drum, a circumferential cavity surrounding the interior mixing chamber, an exterior section in the wall, and a second set of apertures in the exterior section, wherein a receiver coupled to a suction source can engage the exterior section to draw air from within the interior mixing chamber, through the first set of apertures, into the circumferential cavity, through the second set of apertures and into the receiver, and at least some airborne flavoring material is deposited onto food portions through which the air passes on it path. The exterior section may be in an anterior wall surrounding an inlet of the tumble drum or a circumferential portion of the exterior.

### BACKGROUND

### Field of the Invention

The present invention relates to a tumble drum for use in applying flavoring materials to food portions that can recover and deposit at least some airborne flavoring material that would otherwise be lost into the environment onto the food portions. The tumble drum can be used with existing equipment to remove airborne flavoring material from the environment in which the tumble drum operates. More specifically, the present invention relates to a tumble drum adapted for controllably withdrawing air from an interior mixing chamber of the tumble drum in a manner that promotes deposition of at least some of the airborne flavoring material within the interior mixing chamber onto the food portions disposed within the tumble drum and for suppressing airborne flavoring material to prevent unwanted exposure of persons in the facility environment.

### Background of the Related Art

Many prepared foods are subjected to the application of flavoring materials during processing and prior to packaging in airtight enclosures such as, for example, bags. These prepared foods are often gently rolled or agitated in a tumble drum as a flavoring material such as, for example, salt and/or seasoning, is applied. Proper usage of the tumble drum ensures a favorably uniform application of the flavoring material to the food portions processed therein. The food portions are fed into an inlet of the tumble drum, flavoring material is dispensed over the food portions as the tumble drum rotates, and the food portions mixed with flavoring material are discharged through an outlet of the tumble drum.

Many flavoring materials generate airborne dust during application, and the dust can foul machinery. Also, personnel present within the processing facility environment may be sensitive to airborne dust generated during the application of the flavoring materials such as seasoning. In some cases, the generation of airborne dust that escapes the tumble drum during application of flavoring materials represents a loss of a very expensive material, thereby impacting the profitability of the food processing operation in addition to generating an airborne material to which personnel may be highly sensitive.

One solution is to draw air from the facility environment and move it through filters adapted for removing the airborne dust and flavoring material from the air. The expensive flavoring material removed in this manner is lost, but personnel working in the facility environment may be spared at least some exposure to the material.

### BRIEF SUMMARY

One embodiment of the present invention provides an apparatus for mixing a flavoring material with food portions, the apparatus comprising a tumble drum having an interior mixing chamber with an inlet at a first end, an outlet at a second end opposite the first end, a wall intermediate the inlet and the outlet and generally surrounding the interior mixing chamber, an axis extending through the inlet and the outlet about which the tumble drum can rotate, a circumferential cavity in fluid communication through a first set of apertures with the interior mixing chamber and also in fluid communication with a second set of apertures in an exterior section of the tumble drum, and a receiver supported relative to the axis of the tumble drum, the receiver having an inlet with a face conforming to the shape of at least an angular portion of the exterior section of the tumble drum and an outlet portion, wherein coupling the outlet portion of the receiver to a suction source with the inlet of the receiver engaged with at least a portion of the exterior section of the tumble drum draws air from the interior mixing chamber through the first set of apertures, then through the circumferential cavity, then through the second set of apertures to the inlet of the receiver, then through the outlet of the receiver.

Embodiments of the apparatus may further include a plurality of dividers angularly spaced within the circumferential cavity, wherein the plurality of dividers impair circumferential movement within the circumferential cavity of air drawn from the interior mixing chamber. The dividers isolate the suction provided through the receiver to the exterior section to one circumferential segment of the cavity (or to two adjacent circumferential segments of the cavity when the divider is straddled by the receiver) and prevents air from being drawn into the cavity through the full second set of apertures in the exterior section of the tumble drum, which would cause unwanted loss of suction and would impair sweeping of the interior mixing chamber and deposit of the airborne flavoring material onto the food portions within the interior mixing chamber. In one embodiment, the dividers within the cavity may be separated one from the others by a circumferential arc exceeding an arc length of the inlet of the receiver. This arrangement will better isolate the suction source coupled to the receiver from unwanted circumferential flow of air within the cavity. The dividers may reside in a plane that includes the axis of the tumble drum, and the dividers may be equiangularly spaced one from the others. For example, but not by way of limitation, the dividers may be disposed in the circumferential cavity at 45 degrees (0.785 radians) apart to divide the circumferential cavity into eight segments, 30 degrees (0.524 radians) apart to divide the circumferential cavity into 12 segments or 90 degrees (1.571 radians) apart to divide the circumferential cavity into 4 segments. There no requirement that the dividers be disposed equiangularly spaced one from the others.

It will be understood that the source of suction coupled to the receiver for engagement with the exterior section of the tumble drum and, through the second set of apertures, the cavity and the first set of apertures, to the interior mixing chamber may be provided an air mover. For example, but not by way of limitation, an electric motor driven squirrel cage (centrifugal) air mover can be provided, and the inlet to the air mover can be coupled to the outlet of the receiver using a duct to draw air laden with airborne flavoring material downwardly within the interior mixing chamber and through the food portions within the interior mixing chamber, through the first set of apertures, into the circumferential cavity, through the second set of apertures in the exterior section of the tumble drum, into the inlet of the receiver, through the outlet of the receiver, and towards the air mover.

One embodiment of the apparatus further includes a filter media disposed intermediate the outlet of the receiver and an inlet to the air mover to capture airborne flavoring material entrained in the air drawn from the interior mixing chamber. Although the flavoring material captured in the filter media is not ordinarily recoverable, the filter media can capture airborne flavoring material to prevent unwanted airborne flavoring material from entering the facility environment in which the food portions are processed.

One embodiment of the apparatus may further include an adjustable valve disposed intermediate the outlet of the receiver and an inlet to the air mover. The valve can be adjusted to modulate the volumetric rate of air flow from the interior mixing chamber and to thereby optimize deposition of the flavoring material from within the interior mixing chamber onto the food portions in the tumble drum.

In one embodiment of the apparatus of the present invention, the exterior section of the tumble drum includes a radially inwardly recessed channel in the exterior section of the tumble drum. The radially inwardly recessed channel may be, for example, but not by way of limitation, in an exterior section that is on a cylindrical exterior portion or on a frustoconical exterior portion of the tumble drum. “Radially inwardly recessed,” as that term is used herein, means that the channel in the exterior section is recessed towards the interior mixing chamber and in the direction of the axis of the tumble drum when the exterior section is on a cylindrical exterior portion or on a frustoconical exterior portion of the tumble drum.

In one embodiment of the apparatus of the present invention, the radially inwardly recessed channel in the exterior section of the tumble drum is continuous in that it extends about the entire circumference of the tumble drum.

In another embodiment of the apparatus of the present invention, the radially inwardly recessed channel in the exterior section of the tumble drum is in fluid communication through a second set of apertures with a circumferential cavity that is in fluid communication through a first set of apertures with the interior mixing chamber of the tumble drum. This arrangement permits air to be drawn from the interior mixing chamber, through the first set of apertures, into the circumferential cavity that surrounds the interior mixing chamber, through the second set of apertures, and to the exterior section where a receiver engages the exterior section of the tumble drum. The receiver may be coupled to a suction source to provide for drawing air laden with airborne flavoring material from the interior mixing chamber.

In one embodiment of the tumble drum of the present invention, the circumferential cavity that surrounds the interior mixing chamber is segmented by angularly spaced dividers that impair circumferential movement of air within the cavity of the tumble drum.

In one embodiment of the apparatus of the present invention, a receiver is adapted to engage an exterior section of the tumble drum. The receiver has an inlet that is adapted to engage the exterior section of the tumble drum and includes a radially inwardly recessed channel having a protruding face that is shaped to be received into the radially inwardly recessed channel of the tumble drum so that, when the outlet of the receiver is coupled to a suction source, such the suction inlet to an air mover, the receiver will draw air out of the interior mixing chamber, through the first set of apertures, into the circumferential cavity that surrounds the interior mixing chamber, through the second set of apertures in the exterior section of the tumble drum, into the inlet of the receiver, through the outlet of the receiver and towards the suction source.

In another embodiment of the apparatus of the present invention, the exterior section of the tumble drum includes a radially outwardly protruding rail on the exterior section of the tumble drum. The radially outwardly protruding rail may be, for example, but not by way of limitation, on a cylindrical exterior portion or on a frustoconical exterior portion of the tumble drum. “Radially outwardly protruding,” as that term is used herein, means that the rail protrudes outwardly and away from the interior mixing chamber and in the direction away from the axis of the tumble drum. In one embodiment of the apparatus of the present invention, the radially outwardly protruding rail on the exterior section of the tumble drum is continuous in that it extends about the entire circumference of the tumble drum. A receiver that has an inlet that is adapted for engagement with a tumble drum having an exterior section that includes a radially outwardly protruding rail will include a recessed face that is shaped to be received onto the radially outwardly protruding rail so that, when the outlet of the receiver is coupled to a suction source, such as an air mover, the receiver will draw air out of the interior mixing chamber, through the first set of apertures, into the circumferential cavity that surrounds the interior mixing chamber, through the second set of apertures in the exterior section of the tumble drum, into the inlet receiver, out of the outlet of the receiver and towards the suction source.

In another embodiment of the apparatus of the present invention, the exterior section of the tumble drum is on an anterior wall of the tumble drum that surrounds the inlet of the tumble drum. The anterior wall of the tumble drum may lie in a plane that is perpendicular to the axis of the tumble drum or, alternately, the anterior wall may have a substantial radial component that, although it may not lie in a plane that is precisely perpendicular to the axis of the tumble drum, if projected to the axis, it forms a substantial angle with the axis of the tumble drum or is substantially perpendicular to the axis of the tumble drum. The exterior section of the tumble drum may be on the anterior wall and it may be an axially inwardly recessed channel in the anterior wall of the tumble drum that surrounds the inlet of the tumble drum. “Axially,” as that term is used herein, means extending along the axis of the tumble drum or having a substantial axial component of the angle that the recessed channel makes along the axis of the tumble drum. An axially inwardly recessed channel in the anterior wall of the tumble drum is recessed inwardly towards the interior mixing chamber and in a direction along or substantially along the axis about which the tumble drum rotates. A receiver that has an inlet adapted to engage with an exterior section of the tumble drum that includes a axially inwardly recessed channel in the anterior wall of the tumble drum will include a protruding face that is shaped to be received into the axially inwardly recessed channel in the anterior wall of the tumble drum so that, when the outlet of the receiver is coupled to a suction source, such as an air mover, the receiver will draw air out of the interior mixing chamber, through the first set of apertures, into the circumferential cavity that surrounds the interior mixing chamber, through the second set of apertures in the exterior section of the tumble drum and into the inlet of the receiver.

In another embodiment, the apparatus of the present invention may include a tumble drum that has an exterior section that includes an axially outwardly protruding rail in the anterior wall of the tumble drum surrounding the inlet of the tumble drum. A receiver that has an inlet that is adapted to engage with a tumble drum having an exterior section that includes an axially outwardly protruding rail will include a recessed face that is shaped to be received onto the axially outwardly protruding rail so that, when the outlet of the receiver is coupled to a suction source, such as an air mover, the receiver will draw air out of the interior mixing chamber, through the first set of apertures, into the circumferential cavity that surrounds the interior mixing chamber, through the second set of apertures in the exterior section of the tumble drum and into the inlet of the receiver.

In a preferred embodiment of the apparatus of the present invention, the receiver is supported relative to the axis of the tumble drum to engage at least a portion of the exterior section of the tumble drum that is proximal a lowermost portion of the exterior section wherein at least a portion of the air drawn from the interior mixing chamber to the receiver moves through food portions that are supported within the interior mixing chamber of the tumble drum before the air passes through the first set of apertures and into the circumferential cavity that surrounds the interior mixing chamber. The receiver is supported at a stationary position relative to the axis of the tumble drum and, in some embodiments, may be supported by the same frame that supports the tumble drum as it rotates about its axis. It will be understood that by strategically locating the receiver proximal to the lowermost portion of the exterior section of the tumble drum, the receiver remains in a position to draw air laden with flavoring material downwardly within the mixing chamber and through the food portions that will, due to gravity, reside proximal to the bottom or lowermost portion of the interior mixing chamber. Further, it will be understood that, in embodiments of the apparatus in which the tumble drum includes radially inwardly protruding flutes to promote agitation and turning of the food portions within the interior mixing chamber as the tumble drum rotates about its axis, the receiver may be supported at a stationary position proximal the lowermost portion of the exterior section of the tumble drum but slightly angularly offset from the lowermost point of the exterior section because the rotation of the tumble drum with inwardly extending flutes causes the bed of food portions within the interior mixing chamber to be angularly offset from the lowermost point. In this embodiment, the deposition of the flavoring material entrained in the air drawn from the interior mixing chamber is optimized by drawing the air through the thickest and densest portion of the bed of food portions within the interior mixing chamber. In one embodiment, the angular offset from the lowermost point of the exterior section of the tumble drum at which the center of the receiver is supported in a stationary position is between five and 45 degrees (0.785 radians) separated from the lowermost point of the exterior section in the direction of rotation of the tumble drum. Stated another way, in one embodiment, the angular offset from the lowermost point of the exterior section of the tumble drum at which the center of the receiver is supported in a stationary position is between five and 45 degrees (0.785 radians) clockwise for a tumble drum that rotates about its axis in a clockwise direction as seen from the inlet, and in a counterclockwise direction for a tumble drum that rotates about its axis in a counterclockwise direction as seen from the inlet. This offset ensures that the air laden with flavoring material and drawn from within the interior mixing chamber is drawn downwardly and through the deepest and densest portion of the bed of food portions being processed in the tumble drum for optimal deposition of the airborne flavoring material onto the food portions to prevent unwanted waste of a very expensive flavoring material.

In another preferred embodiment of the apparatus of the present invention, the circumferential cavity includes a plurality of angularly spaced dividers that divide the circumferential cavity into cavity segments and that impair the circumferential movement of air within the cavity. For example, but not by way of limitation, if the dividers are disposed within the cavity and angularly separated by 20 degrees (0.349 radians) between each pair of adjacent dividers, there will be 18 cavity segments that make up the circumferential cavity (for 20 degrees or 0.349 radians of separation). If the dividers are separated at only 10 degrees (or 0.174 radians), there will be 36 cavity segments that make up the circumferential cavity (for 10 degrees or 0.174 radians of separation). In embodiments of the tumble drum of the present invention having an exterior section on a frustoconical exterior portion or on a cylindrical exterior portion of the tumble drum, the dividers are disposed within the circumferential cavity that surrounds the tumble drum and may extend the length of the cavity and along the axis of the tumble drum about which the tumble drum rotates. In embodiments of the tumble drum of the present invention having an exterior section on an anterior wall of the tumble drum, the dividers are disposed within the circumferential cavity that surrounds the tumble drum and may extend the length of the cavity and along the axis of the tumble drum about which the tumble drum rotates and may additionally extend into the portion of the cavity that is proximal the anterior wall and proximal to the exterior section in which the second set of apertures are disposed.

Another embodiment of the apparatus of the present invention comprises a tumble drum for use in processing food portions, the tumble drum comprising an inlet at a first end, an outlet at a second end opposite the first end, an interior mixing chamber intermediate the first end and the second end, the interior mixing chamber surrounded by a wall having an exterior section, an axis extending through the inlet, the interior mixing chamber and the outlet about which the tumble drum can rotate, an anterior wall at the first end of the tumble drum surrounding the inlet and a circumferential cavity proximal to the wall and surrounding the interior mixing chamber, the circumferential cavity having a first set of circumferentially distributed apertures through which the cavity is in fluid communication with the interior mixing chamber, the cavity further being in fluid communication with a second set of circumferentially distributed apertures in the exterior section of the wall of the tumble drum, wherein a receiver coupled to a suction source can be engaged with the exterior section to draw air laden with airborne flavoring material from the interior mixing chamber, through the first set of apertures, into the cavity, through the second set of apertures to the inlet of the receiver and wherein the air drawn from the interior mixing chamber can be filtered to remove airborne flavoring material. In one embodiment of the tumble drum of the present invention, the receiver is engaged proximal to a lowermost portion of the exterior section of the tumble drum and the air drawn from the interior mixing chamber is directed downwardly through the bed of food portions moving within the tumble drum as it rotates to deposit at least some of the airborne flavoring material entrained in the air drawn from the interior mixing chamber onto the food portions as the air is drawn from the interior mixing chamber towards the first set of apertures and the circumferential cavity. One embodiment of the tumble drum further includes a plurality of angularly spaced dividers disposed within the circumferential cavity to impair circumferential movement of air drawn into the cavity from the interior mixing chamber. The angularly spaced dividers separate the circumferential cavity into cavity segments. For example, but not by way of limitation, each of the plurality of angularly spaced dividers are angularly separated from an adjacent divider by between 20 degrees (0.349 radians) and 60 degrees (1.047 radians) to separate the circumferential cavity into six (for dividers angularly separated by 60 degrees or 1.047 radians) to eighteen (for dividers angularly separated by 20 degrees or 0.349 radians) segments.

In one embodiment of the tumble drum of the present invention, the exterior section of the tumble drum comprises one of a radially inwardly recessed circumferential channel in an exterior section of the tumble drum and a radially outwardly protruding circumferential rail in the exterior section of the tumble drum. A radially inwardly recessed circumferential channel is recessed inwardly towards the interior mixing chamber and in the direction of the axis about which the tumble drum rotates, and a radially outwardly protruding circumferential rail protrudes outwardly away from the interior mixing chamber and in the direction radially away from the axis about which the tumble drum rotates.

In another embodiment of the tumble drum of the present invention, the exterior section of the tumble drum comprises one of an axially inwardly recessed channel in the anterior wall of the tumble drum and an axially outwardly protruding rail in the anterior wall of the tumble drum. An axially inwardly recessed channel in the anterior wall of the tumble drum is recessed inwardly towards the interior mixing chamber and in the direction generally parallel to the axis of the tumble drum, and an axially protruding rail in the anterior wall of the tumble drum protrudes outwardly away from the interior mixing chamber and in the direction generally parallel to the axis of the tumble drum.

One embedment of the method of the present invention is a method of applying an airborne flavoring material to a plurality of food portions comprising the steps of providing a tumble drum having an inlet at a first end, an outlet at a second end opposite the first end, an interior mixing chamber intermediate the first end and the second end, the interior mixing chamber surrounded by a wall having an exterior section, an axis extending through the inlet, the interior mixing chamber and the outlet about which the tumble drum can rotate, an anterior wall at the first end of the tumble drum surrounding the inlet and a circumferential cavity proximal to the wall and surrounding the interior mixing chamber, the cavity having a first set of circumferentially distributed apertures through which the cavity is in fluid communication with the interior mixing chamber, the cavity further being in fluid communication with a second set of circumferentially distributed apertures in the exterior section of the wall of the tumble drum, providing a receiver having an outlet coupled to suction source such as, for example, but not by way of limitation, an air mover, and an inlet on the receiver shaped to engage at least a portion of the exterior section of the tumble drum as the tumble drum rotates about the axis, the receiver disposed proximal a lowermost portion of the exterior section of the tumble drum, rotating the tumble drum about the axis while dispensing a flavoring material onto food portions moving within the tumble drum interior mixing chamber and operating the air mover to draw air laden with airborne flavoring material downwardly towards the lowermost portion of the tumble drum, through the bed of food portions accumulated within the interior mixing chamber, through the first set of apertures, into the circumferential cavity, through the second set of apertures of the exterior section, into the inlet of the receiver and through the outlet of the receiver towards the suction source. In one embodiment, the method further comprises the steps of providing a filter housing having an inlet and an outlet, providing a filter media within the filter housing, fluidically coupling the inlet of the filter housing to the outlet of the receiver and fluidically coupling the outlet of the filter housing to the air mover, wherein the air drawn from the interior mixing chamber can be filtered through the filter media to remove residual airborne flavoring material that is not deposited onto the bed of food portions in the interior mixing chamber.

In one embodiment of the apparatus of the present invention, the apparatus includes a receiver that is supported in a stationary position and in engagement with the exterior section of the tumble drum at a position proximal to the lowermost portion of the exterior section of the tumble drum. This arrangement strategically disposes the receiver at a position that causes air laden with flavoring material within the interior mixing chamber of the tumble drum to downwardly move through the bed of food portions accumulated at the bottom or lowermost portion of the interior mixing chamber of the tumble drum and to recover at least that portion of the flavoring material that deposits onto or adheres onto the food portions as the air is withdrawn from the interior mixing chamber through the food portions, through the first set of apertures, into the circumferential cavity of the tumble drum, through the second set of apertures in the exterior section of the wall of the tumble drum and to the inlet of the receiver.

In one embodiment of the apparatus of the present invention, the receiver is supported in engagement with the tumble drum at a position that is slightly angularly offset from the lowermost portion of the exterior section in the direction of movement of the lowermost portion of the exterior section, wherein an angle of offset of the receiver from the lowermost portion of the exterior section of the tumble drum is between one degree and thirty degrees. This arrangement provides for an even more strategic placement of the receiver to move air withdrawn from the interior mixing chamber of the tumble drum through the portion of the wall of the tumble drum that will be adjacent to the greatest accumulation of the food portions. It will be understood that in drums, agitators, dryers, etc., a drum may have a plurality of vanes or flutes extending radially inwardly from the wall of the drum to prevent the articles within the rotating drum from merely sliding along the wall. These flutes or vanes cause the largest accumulation in the interior mixing chamber of the tumble drum to be slightly angularly offset from the lowermost portion of the tumble drum and to instead me angularly offset in the direction of movement of the lowermost portion of the tumble drum.

One embodiment of the apparatus of the present invention further includes a valve disposed intermediate the air mover and the receiver, the valve being adjustable to modulate the rate at which air is drawn from the interior mixing chamber.

Other embodiments of the apparatus of the present invention will become apparent as a result of the description of an embodiment that follows. The invention is limited only by the claims appended hereto.

### BRIEF DESCRIPTION OF THE SEVERAL VIEWS OF THE DRAWINGS

FIG. 1 is a perspective view of a receiver of an embodiment of an apparatus of the present invention having an inlet shaped to engage an exterior section of a tumble drum having a radially inwardly recessed channel.

FIG. 2 is an elevation view of a tumble drum of an embodiment of an apparatus of the present invention having an exterior section with a radially inwardly recessed channel with a second set of circumferentially distributed apertures therein.

FIG. 3 is a sectional elevation view of the tumble drum of FIG. 2 revealing a first set of apertures through which segments of the circumferential cavity that surrounds the interior mixing chamber of the tumble drum are in fluid communication with the interior mixing chamber of the tumble drum and a second set of apertures in an exterior section of the tumble drum through which the segments of the circumferential cavity can be disposed in fluid communication with a receiver that engages the exterior section of the tumble drum.

FIG. 4 is the sectional elevation view of FIG. 3 after a receiver, having an inlet shaped to engage the exterior section of the tumble drum, engages the exterior section as the tumble drum rotates about an axis.

FIG. 5 is a schematic showing a system for depositing at least some of the airborne flavoring material in air drawn from the interior mixing chamber onto food portions within the interior mixing chamber of the tumble drum and for capturing residual flavoring material remaining in the air drawn from an interior mixing chamber of the tumble drum and through the bed of food portions.

FIG. 6 is a perspective view of an alternate receiver of an embodiment of an apparatus of the present invention having an inlet shaped to engage an exterior section of a tumble drum having a radially outwardly protruding rail.

FIG. 7 is an elevation view of a tumble drum of an embodiment of an apparatus of the present invention having an exterior section with a radially outwardly protruding rail with a plurality of circumferentially distributed apertures therein.

FIG. 8 is a sectional elevation view of the tumble drum of FIG. 7 revealing a first set of apertures intermediate an interior mixing chamber and a circumferential cavity of a tumble drum that surrounds the interior mixing chamber and a second set of apertures in a radially outwardly protruding rail in an exterior section of the tumble drum through which the circumferential cavity is in fluid communication with a receiver that engages the radially outwardly protruding rail on the exterior section of the tumble drum.

FIG. 9 is the sectional elevation view of FIG. 8 after a receiver, having an inlet adapted for engagement with the radially outwardly protruding rail of the tumble drum, is disposed into engagement with the rail as the tumble drum rotates about an axis.

FIG. 10 is a sectional elevation view of a tumble drum of another embodiment of the apparatus of the present invention revealing a first set of apertures intermediate the interior mixing chamber of the tumble drum and the circumferential cavity and a second set of apertures in an exterior section of the tumble drum having an axially inwardly recessed channel in an anterior wall of the tumble drum through which the cavity can be disposed in fluid communication with a receiver that engages the axially inwardly recessed channel in the exterior section.

FIG. 11 is an anterior elevation view of the tumble drum of FIG. 10 showing the axially inwardly recessed channel in the anterior wall of the tumble drum. FIG. 11 further reveals a plurality of dividers (in broken lines) disposed within the circumferential cavity of the tumble drum to divide the circumferential cavity into segments and thereby impair circumferential movement of air drawn from the interior mixing chamber within the cavity. It will be understood that FIG. 11 is very similar to the elevation view of the tumble drum of FIG. 14 showing an axially outwardly protruding rail in the anterior wall of the tumble drum.

FIG. 12 is a perspective view of a receiver of an embodiment of an apparatus of the present invention having an inlet adapted for engaging an exterior section in an anterior wall of the tumble drum having an axially inwardly recessed channel like that shown in FIG. 11.

FIG. 13 is a sectional elevation view of the tumble drum of FIG. 10 with the receiver of FIG. 12 engaged with the exterior section.

FIG. 14 is an anterior elevation view of the tumble drum of FIG. 13 showing the axially outwardly protruding rail on the anterior wall of the tumble drum. It will be understood that the view of FIG. 14 is very similar to the elevation view of a tumble drum of FIG. 11 showing an axially inwardly recessed channel in the exterior section on the anterior wall of the tumble drum, but without the dividers in the cavity.

FIG. 15 is a perspective view of a receiver having an inlet adapted to engage the axially outwardly protruding rail of the tumble drum of FIGS. 13 and 14. The inlet of the receiver includes a plurality of apertures.

FIG. 16 is an elevation sectional view of the tumble drum of FIG. 13 with the receiver of FIG. 15 engaging the exterior section having an axially outwardly protruding rail to draw air laden with airborne flavoring material in the interior mixing chamber through food portions within the lowermost portion of the interior mixing chamber.

### DETAILED DESCRIPTION

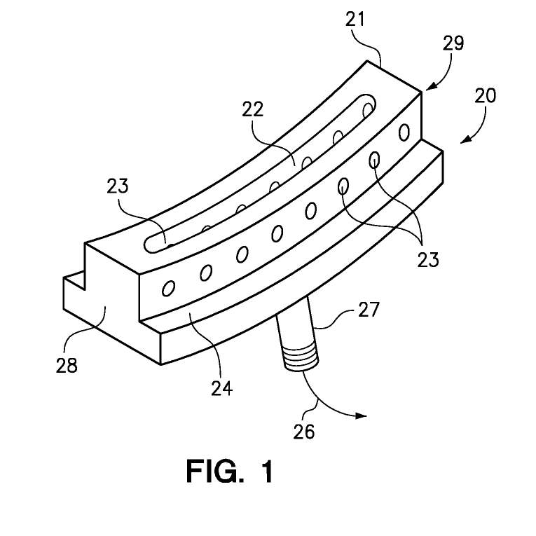

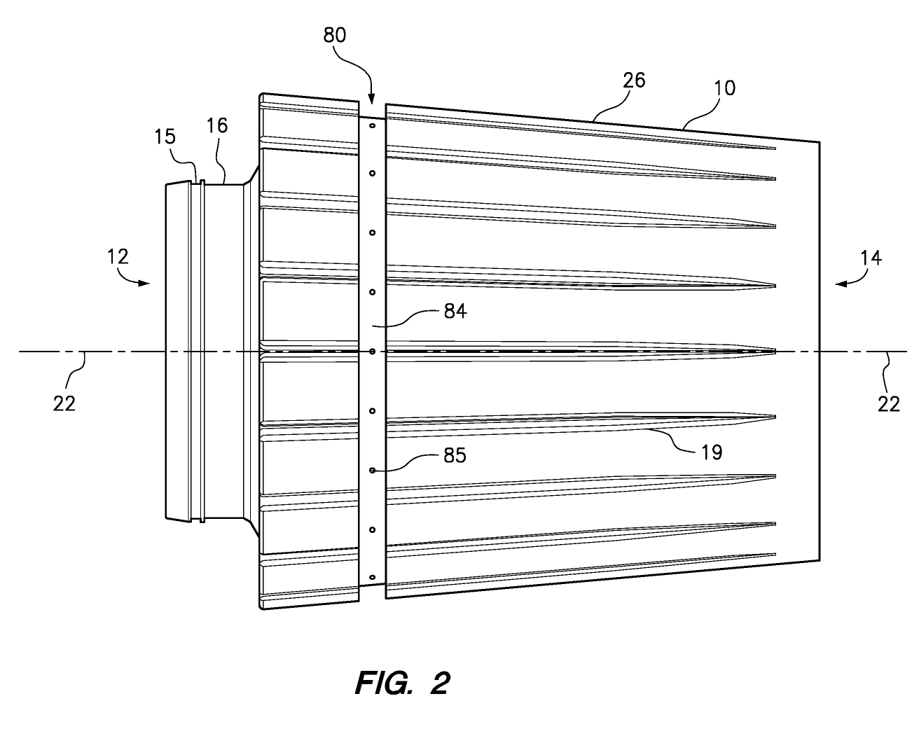

FIG. 1 is a perspective view of a receiver 20 of an embodiment of an apparatus of the present invention having an inlet 22 adapted to engage an exterior section 84 of a tumble drum 10 (not shown) having a radially inwardly recessed channel 80 (see FIG. 2). The inlet 22 of the receiver 20 of FIG. 1 includes a protruding face portion 21, the face portion 21 having a plurality of openings 23 for receiving air drawn from the tumble drum 10 into the inlet 22 of the receiver 20. The receiver 20 further includes an outlet 27 through which air drawn into the inlet 22 of the receiver 20 through the openings 23 can be drawn from the receiver 20 in the direction of arrow 26. The receiver 20 of FIG. 1 further includes a flange portion 24 surrounding the face portion 21, a leading end 28 and a trailing end 29, both the face portion 21 and the flange portion 24 being curved to conform to the exterior section 84 of a tumble drum 10 to be engaged by the receiver 20, as discussed further below. It will be understood after the discussion below that the leading end 28 and the trailing end 29 may switch positions depending on the direction of rotation of the tumble drum 10 about its axis 22 (see FIG. 2).

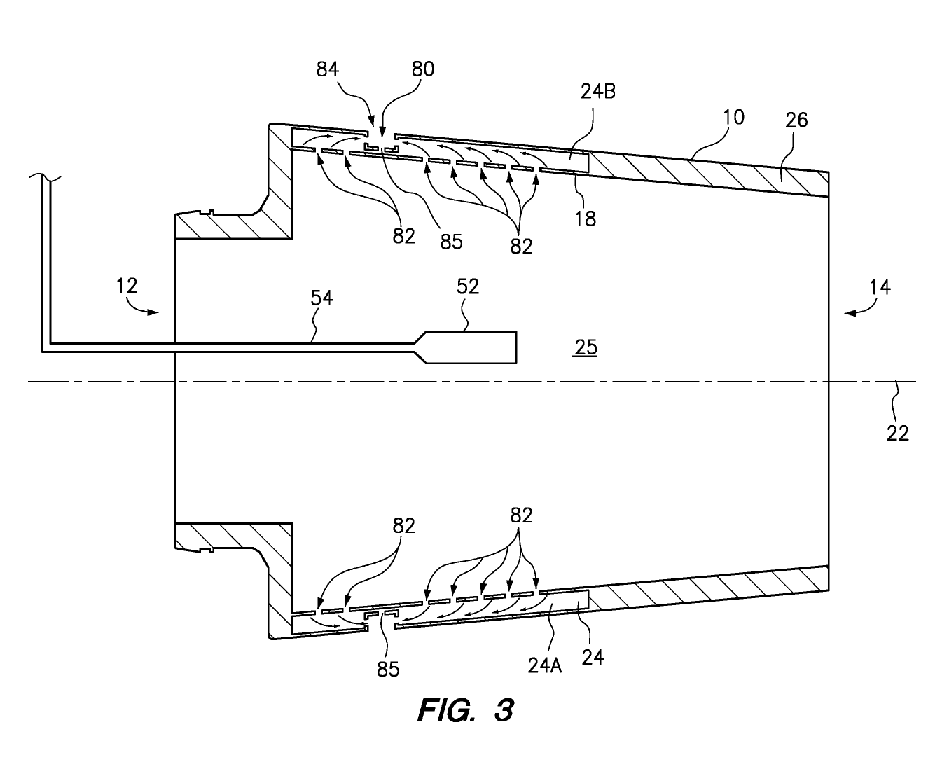

FIG. 2 is an elevation view of a tumble drum 10 of an embodiment of an apparatus of the present invention having an exterior section 84 with a radially inwardly recessed channel 80 with a second set of angularly distributed apertures 85 therein (the first set of angularly distributed apertures 82 shown in FIG. 3 and discussed below). The tumble drum 10 of FIG. 2 has in inlet 12 and an outlet 14, a neck 16 for supporting and rotating the tumble drum 10 about an axis 22, and a plurality of angularly distributed stiffening flutes 19 in the wall 26 of the tumble drum 10. The neck 16 includes circumferential ribs 15 for securing the neck 16 to a support (not shown).

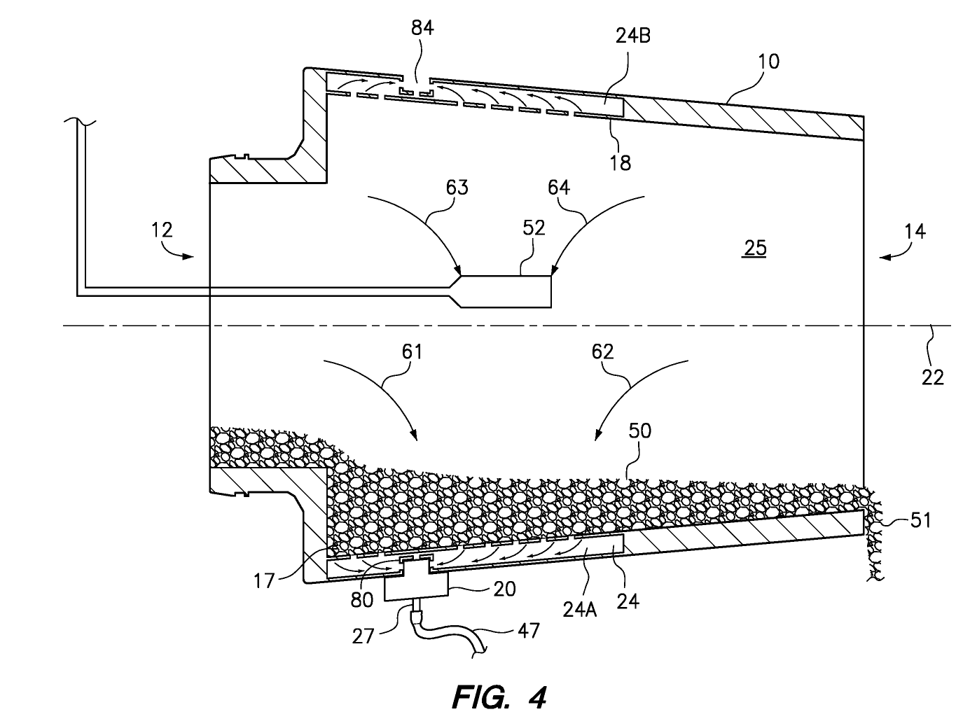

FIG. 3 is a sectional side elevation view of the tumble drum 10 of FIG. 2 revealing a segmented circumferential cavity 24 with cavity segments 24A and 24B in fluid communication with the interior mixing chamber 25 through a first set of apertures 82 and in fluid communication with the radially inwardly recessed channel 80 in the exterior section 84 of the wall 26 of the tumble drum 10 through the second set of apertures 85. The second set of apertures 85 in the exterior section 84 of the tumble drum 10 are disposed within the radially inwardly recessed channel 80 formed in the exterior section 84 that extends circumferentially around the tumble drum 10. A dispenser 52 which may be, for example, but not by way of limitation, a screw-drive dispenser, is supported by support 54 within the interior mixing chamber 25 of the tumble drum 10 to dispense flavoring material (not shown) onto food portions (not shown). In FIG. 3, the first set of apertures 82 and the second set of apertures 85 appear to be about the same size for purposes of illustration. The second set of apertures 85 in the radially inwardly recessed channel 80 of the exterior section 84 of the tumble drum 10 and the first set of apertures 82 intermediate the circumferential cavity 24 and the interior mixing chamber 25 may be, but need not be, of the same in size or. For example, but not by way of limitation, the first set of apertures 82 may be greater in number and smaller in size than the second set of apertures 85 to prevent unwanted food particles or crumbs within the interior mixing chamber 25 from entering the circumferential cavity 24 (including cavity segments 24A and 24B) while still enabling the flow of air laden with flavoring material from the interior mixing chamber 25 into the circumferential cavity 24 and from the circumferential cavity 24 to a receiver 20 (not shown—see FIG. 4) engaged with the exterior section 84 of the tumble drum 10. It will be understood that although FIG. 3 shows the circumferential cavity 24 of the tumble drum 10 to be segmented into cavity segments 24A and 24B, this is optional and is included in FIG. 3 merely for purposes of illustration.

FIG. 4 is the sectional side elevation view of the tumble drum 10 of FIG. 3 after a receiver 20, adapted to engage the radially inwardly recessed channel 80 of the exterior section 84 of the tumble drum 10, is positioned to engage a lowermost portion of the channel 80 as the tumble drum 10 rotates about an axis 22. The dispenser 52 dispenses flavoring material (not shown) onto the food portions 50 therebelow as the tumble drum 10 rotates about the axis 22 to mix the flavoring material (not shown) with the food portions 50. FIG. 4 illustrates how food portions 50 may accumulate in the lowermost portion of the interior mixing chamber 25 during use. Food portions 50 are added to the interior mixing chamber 25 through the inlet 12 of the tumble drum 10 and are removed at the outlet 14. A receiver 20 engages the radially inwardly recessed channel 80 of the exterior section 84 of the tumble drum 10 and the outlet 27 of the receiver 20 is coupled to a duct 47 through which suction is applied to the receiver 20 to draw air laden with airborne flavoring material (not shown) downwardly within the interior mixing chamber 25 of the tumble drum 10 as illustrated by arrows 61, 62, 63 and 64, towards and then through the bed of food portions 50. It will be understood that as air is withdrawn from the interior mixing chamber 25 to the receiver 20, replacement air will enter the interior mixing chamber 25 through the inlet 12 and the outlet 14 of the tumble drum 10. It will be further understood that by disposing the receiver 20 proximal to the lowermost portion 17 of the interior mixing chamber 25 of the tumble drum 10, any airborne flavoring material (not shown) entrained or floating in the air within the interior mixing chamber 25 will be drawn downwardly and through the bed of accumulated food portions 50, and at least some of the airborne flavoring material will be advantageously deposited onto the food portions 50 thereby preventing the airborne flavoring material from being released into the environment in which the tumble drum 10 operates and thereby wasted.

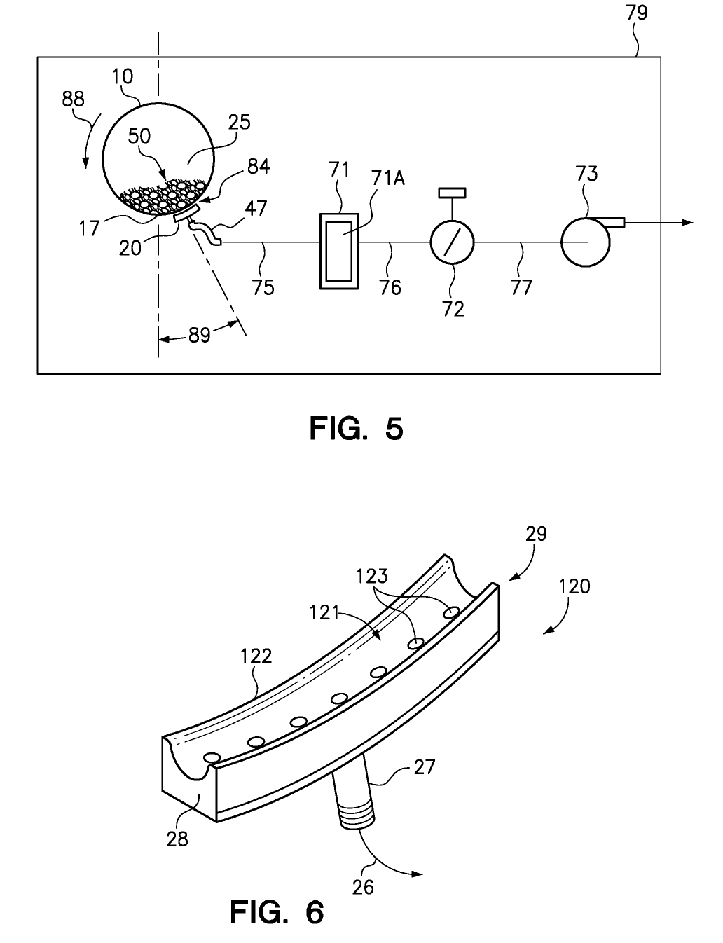

FIG. 5 is a schematic showing a system 79 for recovering at least some of the airborne flavoring material from air drawn from an interior mixing cavity 25 of the tumble drum 10 of the apparatus of the present invention and for suppressing the release of flavoring material into the environment surrounding the tumble drum 10. The tumble drum 10 of FIG. 5 is shown in a sectioned view with a bed of food portions 50 therein. The receiver 20 of FIG. 5 engages the exterior section 84 (see FIG. 2-4) of the tumble drum 10 to withdraw air from the interior mixing chamber 25. The withdrawn air laden with flavoring material passes through the bed of food portions 50 in the tumble drum 10 to deposit at least some of the flavoring material therein onto the food portions 50 and, at the same time, to prevent that flavoring material from escaping the tumble drum 10 into the environment in which the tumble drum 10 operates. The withdrawn air moves from the interior mixing chamber 25, through the food portions 50, through the receiver 20 and through the duct 47 to a filter feed duct 75 (shown as single line for illustration purposes) that carries the air and residual flavoring material not deposited on the food portions 50 to a filter housing 71 where residual flavoring material is filtered from the air using, for example, a filtration media cartridge 71A that can be periodically replaced and/or cleaned. The filtered air leaves the filter housing 71 and moves through a valve 72 that can be adjusted to modulate the rate at which air is withdrawn from the interior mixing chamber 25 of the tumble drum 10. Air exiting the valve 72 enters an air mover suction duct 77 that delivers the air to an air mover 73 that discharges the air, for example, outside the facility in which the tumble drum 10 operates. In the system 79 of FIG. 5, the angle 89 of offset of the receiver 20 from the lowermost portion 17 of the exterior section 84 of the tumble drum 10 is between, for example, five degrees and thirty degrees. This angle 89 of offset is provided to draw air from the interior mixing chamber 25 of the tumble drum 10 through the deepest and/or thickest part of the food portions 50 to deposit the maximum amount of flavoring material onto the food portions 50. The deepest and/or thickest part of the food portions 50 is likely to be offset by an angle 89 from the lowermost portion 17 of the tumble drum 10 due to the direction of rotation of the tumble drum 10 as illustrated by arrow 88.

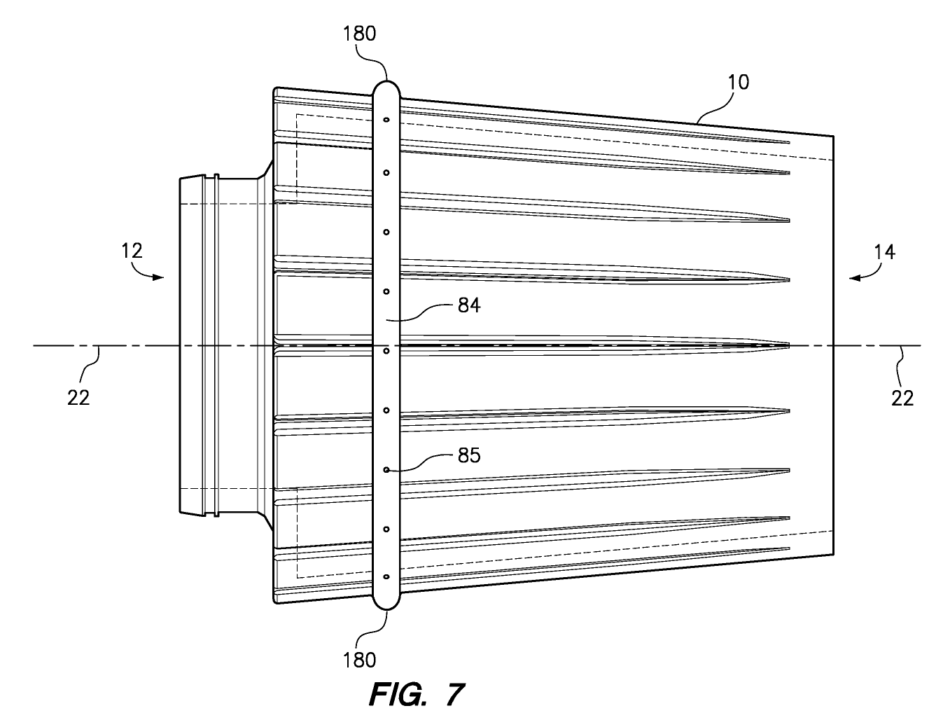

FIG. 6 is a perspective view of an alternate receiver 120 of an embodiment of an apparatus of the present invention having an inlet 122 adapted for engaging an exterior section 84 (not shown in FIG. 6) of a tumble drum 10 (not shown in FIG. 6) having a radially outwardly protruding rail 180 (not shown in FIG. 6—see FIGS. 7-9) instead of a radially inwardly recessed channel 80 shown in FIG. 2-4. The inlet 122 of the alternate receiver 120 of FIG. 6 includes a recessed surface 121 having a plurality of apertures 123 for drawing air into the receiver 120 when the receiver 120 is coupled to a suction source such as, for example, an air mover. The alternate receiver 120 of FIG. 6 further includes an outlet 27 through which air moves in the direction of the arrow 26 to the suction source (not shown in FIG. 6). The receiver 120 of FIG. 6 further includes a leading end 28 and a trailing end 29 which, it will be understood, can be switched when the direction of rotation of the tumble drum 10 (not shown) is reversed.

FIG. 7 is a side elevation view of an alternate tumble drum 10 of an embodiment of an apparatus of the present invention having an inlet 12, an outlet 14, and an exterior section 84 with a radially outwardly protruding rail 180 with a second set of apertures 85, which are circumferentially distributed about the exterior section 84, through which air laden with flavoring material may be withdrawn from the interior mixing chamber 25 (not shown in FIG. 7) of the tumble drum 10 flows to the inlet 122 of the alternate receiver 120 (see FIG. 6) as the tumble drum 10 rotates about its axis 22.

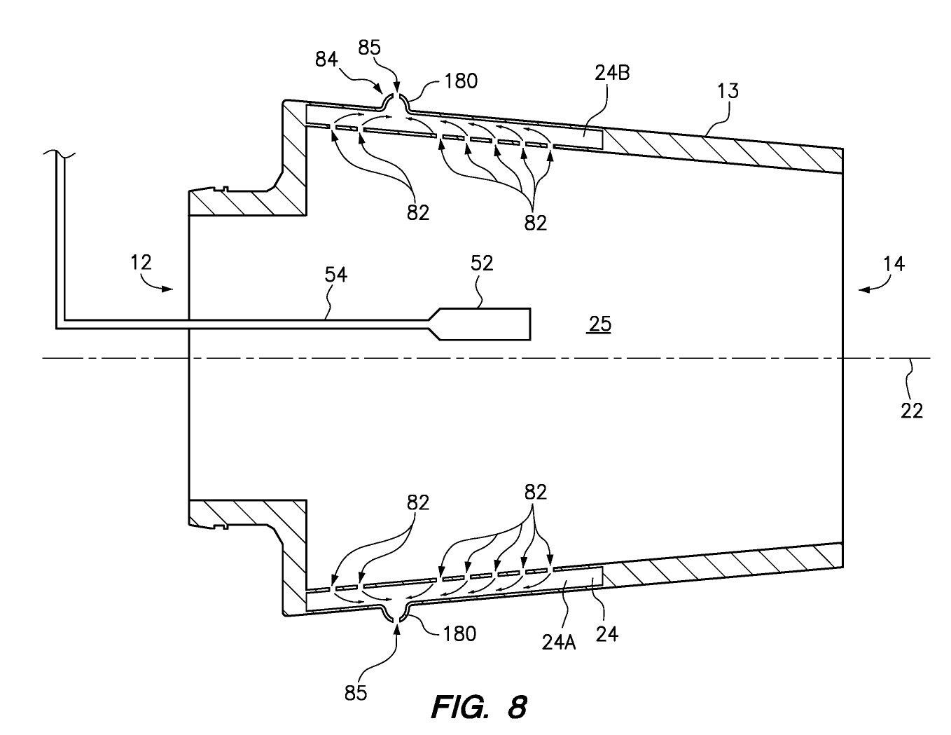

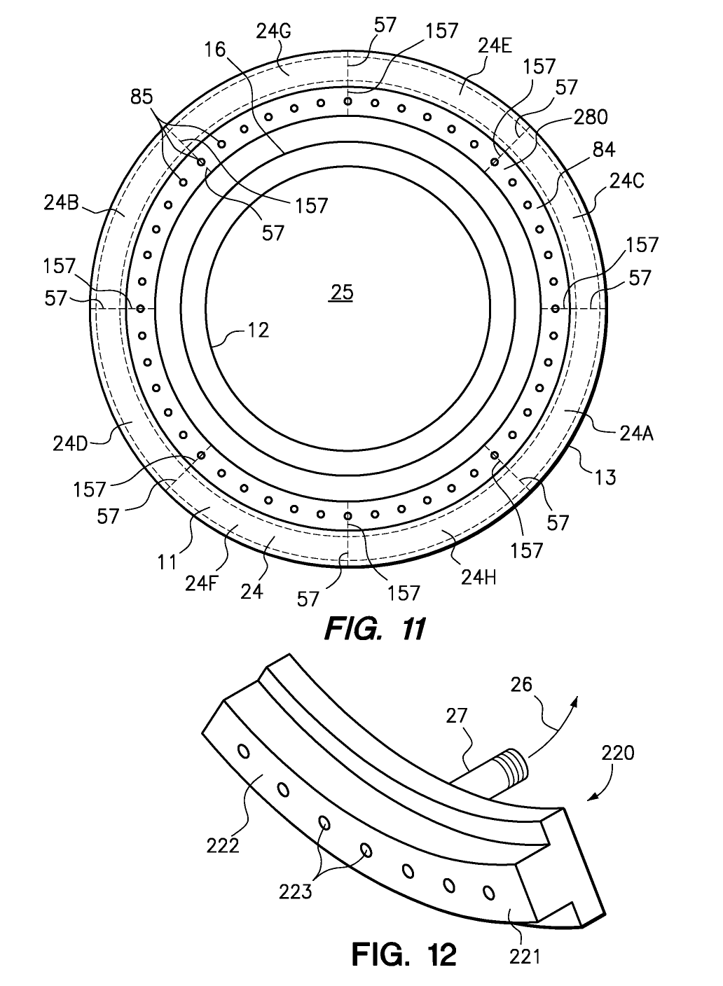

FIG. 8 is a sectional side elevation view of the tumble drum 10 of FIG. 7 revealing a first set of apertures 82 intermediate the interior mixing chamber 25 and the circumferential cavity 24 of the tumble drum 10 that surrounds the interior mixing cavity 25, the first set of apertures 82 proximal to a radially outwardly protruding rail 180 in an exterior section 84 of the tumble drum 10 having the second set of apertures 85. A dispenser 52 which may be supported within the interior mixing chamber 25 of the tumble drum 10 to dispense flavoring material (not shown) onto food portions (not shown). The tumble drum 10 of FIG. 8 is adapted for enabling the withdrawal of air from the interior mixing chamber 25, through the first set of apertures 82 to the circumferential cavity 24, and from the cavity 24 through the second set of apertures 85 in the radially outwardly protruding rail 180 in the exterior section 84 of the tumble drum 10 when a receiver 120 (not shown—see FIG. 7) is engaged with the rail 180 and coupled to a suction source. Optionally, the circumferential cavity 24 can be segmented into segments 24A and 24B to impair circumferential movement of air within the cavity 24 by disposing dividers (not shown—see FIG. 11) within the circumferential cavity 24 to create cavity segments 24A and 24B.

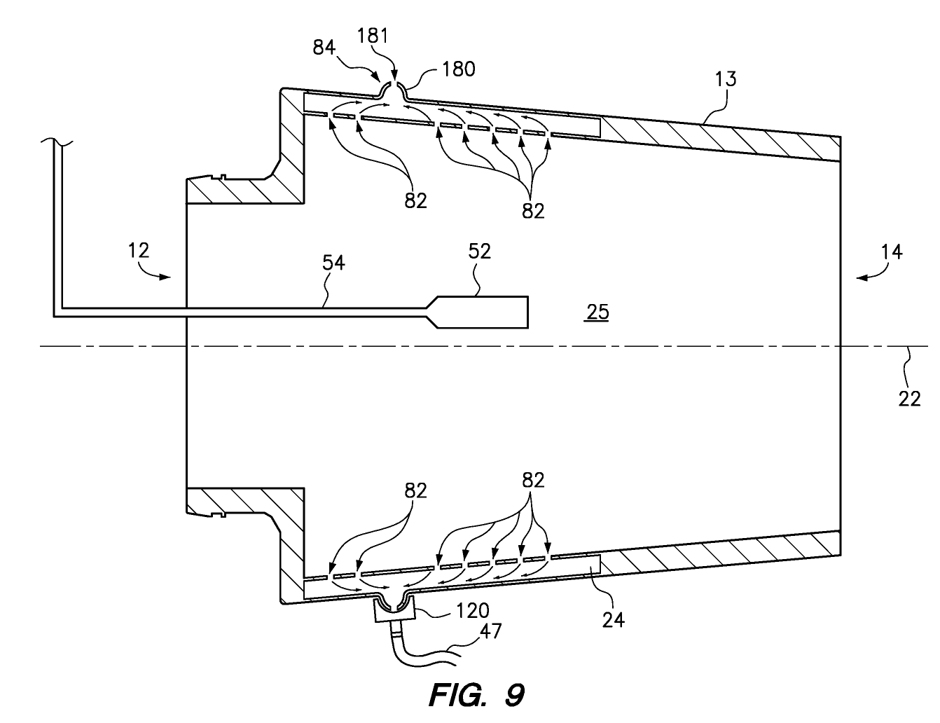

FIG. 9 is the side sectional elevation view of FIG. 8 after a receiver 120, adapted for engagement with the radially outwardly protruding rail 180 of the tumble drum 10 of FIG. 8, engages the rail 180 as the tumble drum 10 rotates about an axis 22. A dispenser 52 which may be supported by support 54 within the interior mixing chamber 25 of the tumble drum 10 to dispense flavoring material (not shown) onto food portions 50 (not shown). The withdrawal of air from the interior mixing chamber 25 of the tumble drum 10 of FIG. 9 through the first set of apertures 82 to the circumferential cavity 24, and from the circumferential cavity 24 through the second set of apertures 181 in the radially outwardly protruding rail 180 in the exterior section 84 of the tumble drum 10 to the receiver 120 enables the deposit of flavoring material entrained in the air within the interior mixing chamber 25 onto the food portions 50 (not shown) and reduces the escape of air laden with flavoring material dispensed from the dispenser 52 into the environment surrounding the tumble drum 10.

It will be understood that, while embodiments of the tumble drum 10 and the receivers 20 and/or 120 illustrated in the appended drawings include a radially inwardly recessed channel 80 (FIGS. 2-4) and a radially outwardly protruding rail 180 (FIGS. 7-9), other embodiments of the exterior section 84 of the tumble drum 10 that is engaged by the receiver 20 and/or 120 may have other shapes and configurations without departing from the spirit of the present invention and the scope of the claims appended hereto. Some of these alternative configurations are discussed below, but do not depart from the primary design of the invention illustrated in the discussion above.

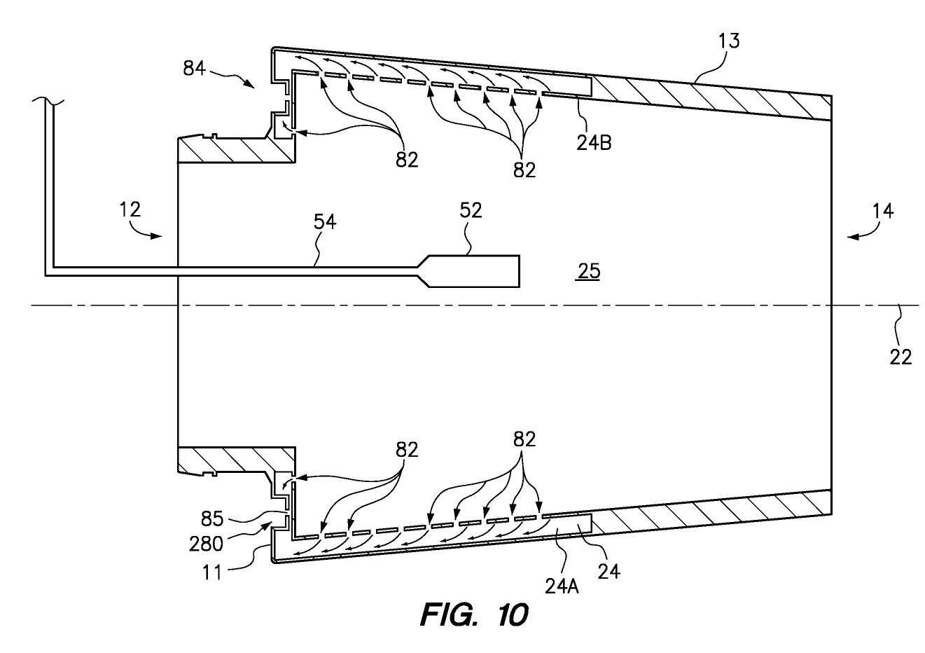

FIG. 10 is a sectional elevation view of an alternative tumble drum 13 of an embodiment of the apparatus of the present invention revealing a first set of apertures 82 intermediate an interior mixing chamber 25 and an adjacent circumferential cavity 24 that surrounds the interior mixing chamber 25 of the tumble drum 10, the first set of apertures 82 disposing the interior mixing chamber 25 in fluid communication with the circumferential cavity 24, and FIG. 10 further shows a second set of apertures 85 in an axially inwardly recessed channel 280 in the exterior section 84 anterior wall 11 of the tumble drum 120. The second set of apertures 85 in the axially inwardly recessed channel 280 is in fluid communication with the first set of apertures 82 and this structure allows air laden with airborne flavoring material to be drawn from the interior mixing chamber 25 through the first set of apertures 82 into the circumferential cavity 24, and from the circumferential cavity 24 through the second set of apertures 85 of the axially inwardly recessed channel 280 in the exterior section 84 in the anterior wall 11 to a receiver 220 (not shown in FIG. 10). Optionally, the circumferential cavity 24 may include dividers (not shown) that divide the circumferential cavity 24 into a plurality of cavity segments 24A and 24B to impair circumferential movement of the air within the circumferential cavity 24.

FIG. 11 is an anterior elevation view of the anterior wall 11 of the tumble drum 13 of FIG. 10 showing the axially inwardly recessed channel 280 in the exterior section 84 of the tumble drum 13. The exterior section 84 is disposed in the anterior wall 11 of the tumble drum 13 of FIG. 11. The axially inwardly recessed channel 280 of the anterior wall 11 of the tumble drum 13 of FIG. 10 surrounds the neck 16 of the tumble drum 13. The interior mixing chamber 25 can be seen through the neck 16 that surrounds the inlet 12 of the tumble drum 13. The axially inwardly recessed channel 280 includes a second set of angularly distributed apertures 85 through which air laden with flavoring material can be drawn from the interior mixing chamber 25 of the tumble drum 13, through the circumferential cavity 24 and through the apertures 85 to the receiver 220 (not shown in FIG. 11—see FIG. 12).

FIG. 11 reveals the optional dividers 57 in the circumferential cavity 24 that divide the circumferential cavity 24 into eight cavity segments 24A, 24B, 24C, 24D, 24E, 24F, 24G and 2411 to impair circumferential movement of air drawn from the interior mixing chamber 25 through the first set of apertures 82 (not shown) into the circumferential cavity 24. It will be understood that the dividers 57 in the circumferential cavity 24 can vary in number and angular spacing one from the others. In embodiments of the apparatus in which the circumferential cavity 24 extends to an exterior surface 84 that is disposed on the anterior wall 11 of the tumble drum 13, the dividers will extend as shown by dividers 157 shown in FIG. 11. In a preferred embodiment, the optional dividers 57 and, optionally, dividers 157, serve to isolate all but one or two of the cavity segments 24A, 24B, 24C, 24D, 24E, 24F, 24G and 2411 from the receiver 20, 120, 220 or 320 shown in FIGS. 1, 6, 12 and 15, respectively, so that a substantial portion of the air is drawn from the interior mixing chamber 25 rather than from outside the tumble drum 13.

FIG. 12 is a perspective view of an alternative receiver 220 that is shaped to engage the axially inwardly recessed channel 280 of the tumble drum 13 of FIGS. 10 and 11 to provide yet another embodiment of an apparatus of the present invention. The receiver 220 of FIG. 12 includes an inlet 222 shaped to engage a portion of the axially inwardly recessed channel 280 of the tumble drum 13 in the anterior portion 11 of the tumble drum 13 of FIGS. 10 and 11. The inlet 222 includes a protruding face portion 221 that can be inserted into the axially inwardly recessed channel 280 of the tumble drum 13, and the inlet 222 of the receiver 220 includes a plurality of apertures 223 through which air flows into the receiver 220. The receiver 220 further includes an outlet 27 for being coupled to a suction source to withdraw air towards the suction source in the direction of arrow 26.

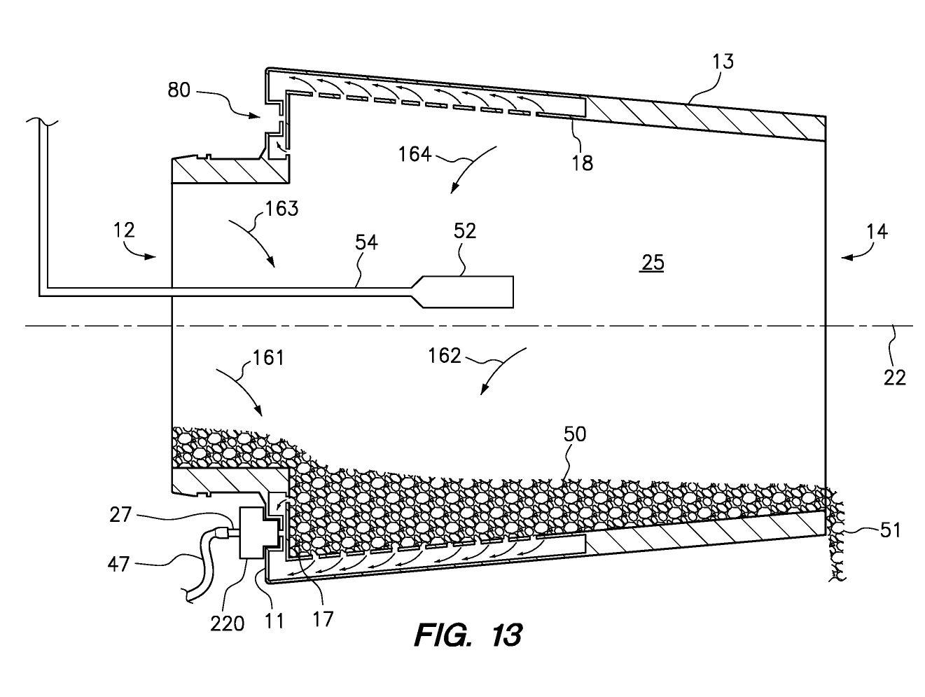

FIG. 13 is a sectional side elevation view of the tumble drum 13 of FIG. 10 with the receiver 220 of FIG. 12 engaged with the axially inwardly recessed channel 280 disposed in the anterior wall 11 of the tumble drum 13 as the tumble drum 13 rotates about the axis 22. The outlet 27 of the receiver 220 is coupled to a duct 47 through which suction is applied to the receiver 220 to draw air laden with airborne flavoring material (not shown) downwardly, as illustrated by arrows 161, 162, 163 and 164, towards the bed of food portions 50. As air is withdrawn from the interior mixing chamber 25 to the receiver 220, replacement air will enter the interior mixing chamber 25 through the inlet 12 and the outlet 14 of the tumble drum 13. By disposing the receiver 220 proximal to the lowermost portion 17 of the interior mixing chamber 25 of the tumble drum 13 and in the anterior wall 11, any airborne flavoring material entrained in the air within the interior mixing chamber 25 will be drawn downwardly and through the bed of food portions 50, and at least some of the flavoring material will be deposited onto the food portions 50 thereby preventing the flavoring material from being released into the environment in which the tumble drum 13 operates.

Although the axially inwardly recessed channel 280 of the anterior wall 11 of FIG. 10 is axially inwardly recessed, it will be understood that the tumble drum 13 of FIG. 10 could include an axially outwardly protruding rail (not shown) much like the radially outwardly protruding rail 180 of FIGS. 7-9.

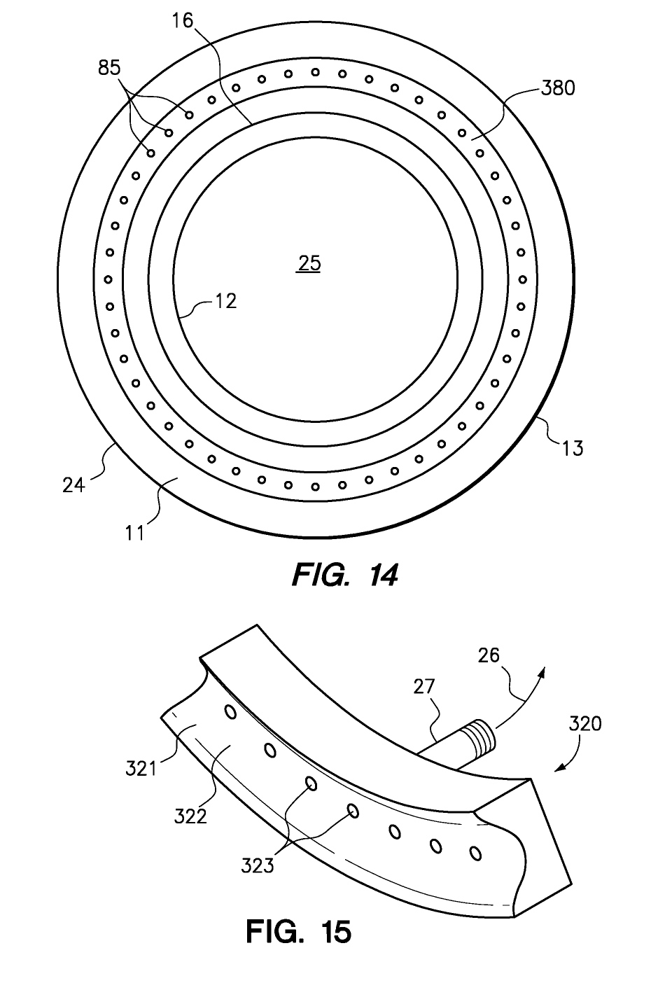

FIG. 14 is an anterior elevation view of the tumble drum of FIG. 13 showing an axially outwardly protruding rail 380 on the anterior wall 11 of the tumble drum 13. The view of FIG. 14 is very similar to the elevation view of a tumble drum 10 of FIG. 11 showing an axially inwardly recessed channel 280 in the anterior wall 11 of the tumble drum 13. The dividers 57 and 157 and the cavity segments 24A, 24B, 24C, 24D, 24E, 24F, 24G and 2411 are not shown in FIG. 14 as they appear the same as in FIG. 11.

FIG. 15 is a perspective view of an alternative receiver 320 having an inlet 322 adapted for engaging the axially outwardly protruding rail 380 of the tumble drum 13 of FIG. 14. The inlet 322 of the receiver 320 includes a recessed face 321 and a plurality of apertures 323 therein for receiving air from the axially outwardly protruding rail 380 of the tumble drum 13. Air is drawn from the receiver through the outlet 27 towards the suction source to which the receiver 320 is coupled and in the direction of the arrow 26.

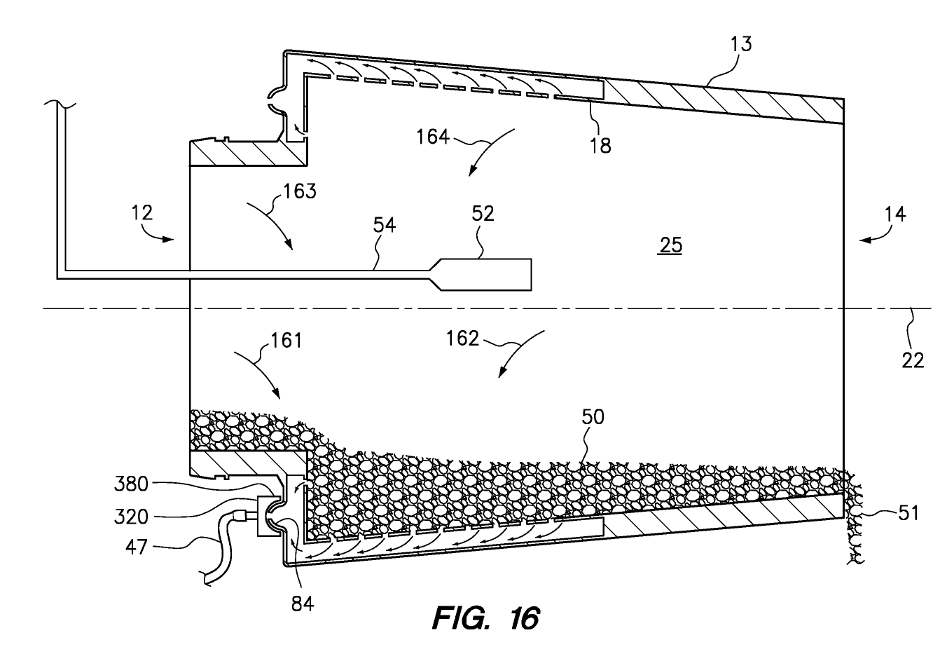

FIG. 16 is an elevation sectional view of the tumble drum 13 of FIG. 14 with the receiver 320 of FIG. 15 engaging the exterior section 84 of the tumble drum 13 having the axially outwardly protruding rail 380 to draw air laden with airborne flavoring material in the direction of arrows 161, 162, 163 and 164 from the interior mixing chamber 25 through food portions 50 within the interior mixing chamber 25. The flavoring material dispenser 52 is supported by support 54 within the interior mixing chamber 25. Replacement air to replace the air withdrawn from the interior mixing chamber 25 enters the tumble drum 13 through the inlet 12 and the outlet 14 as food portions 51 mixed with flavoring material (not shown) exits the outlet 14.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus for mixing a flavoring material with food portions, comprising:
a tumble drum having an interior mixing chamber with an inlet at a first end, an outlet at a second end opposite the first end, a wall surrounding the interior mixing chamber, an axis extending through the inlet and the outlet about which the tumble drum can rotate, a circumferential cavity in fluid communication through a first set of perforations with the interior mixing chamber and in fluid communication with a second set of perforations in an exterior section of the tumble drum; and
a receiver supported relative to the axis of the tumble drum, the receiver having an inlet conforming to the shape of at least an angular portion of the exterior section of the tumble drum and an outlet;
wherein coupling the outlet of the receiver to a suction source with the inlet of the receiver engaged with at least a portion of the exterior section of the tumble drum draws air from the interior mixing chamber through the first set of perforations, then through the circumferential cavity, then through the second set of perforations to the inlet of the receiver, then through the outlet of the receiver.

2. The apparatus of claim 1, further comprising:
a plurality of dividers angularly spaced within the circumferential cavity;
wherein the plurality of dividers impairs circumferential movement within the circumferential cavity of air drawn from the interior mixing chamber.

3. The apparatus of claim 2, wherein the dividers are separated one from the other by an arc exceeding an arc length of the inlet of the receiver.

4. The apparatus of claim 1, wherein the suction source is an inlet of an air mover.

5. The apparatus of claim 4, further comprising:
a filter media disposed intermediate the outlet of the receiver and the air mover to capture airborne flavoring material entrained in the air drawn from the interior mixing chamber.

6. The apparatus of claim 4, further comprising:
an adjustable valve disposed intermediate the outlet of the receiver and the air mover;
wherein the valve can be adjusted to modulate the volumetric rate of air flow from the interior mixing chamber.

7. The apparatus of claim 1, wherein the exterior section of the tumble drum includes one of a radially inwardly recessed channel in the exterior section of the tumble drum and a radially inwardly protruding rail on the exterior section of the tumble drum.

8. The apparatus of claim 1, further comprising:
an anterior wall of the tumble drum surrounding the inlet and having at least a portion that is substantially perpendicular to the axis of the tumble drum; and
one of an axially inwardly recessed channel in an anterior wall of the tumble drum surrounding the inlet of the tumble drum and an axially outwardly protruding rail in the anterior wall of the tumble drum surrounding the inlet of the tumble drum.

9. The apparatus of claim 8, wherein the inlet conforming to the shape of at least an angular portion of the exterior section of the tumble drum comprises at least one of a protruding face conforming in shape to an angular portion of the axially inwardly recessed channel in the anterior wall of the tumble drum and a recessed face conforming in shape to an angular portion of the axially outwardly protruding rail in the anterior wall of the tumble drum.

10. The apparatus of claim 1, wherein the inlet conforming to the shape of at least an angular portion of the exterior section of the tumble drum comprises at least one of a protruding face conforming to the shape of an angular portion of the radially inwardly recessed channel in the exterior section of the tumble drum and a recessed face conforming to the shape of an angular portion of the radially outwardly protruding rail on the exterior section of the tumble drum.

11. The apparatus of claim 1, wherein the receiver is supported to engage at least a portion of the exterior section of the tumble drum proximal a lowermost portion of the exterior section;
wherein at least a portion of the air drawn from the interior mixing chamber to the receiver moves through food portions supported within the interior mixing chamber.

12. The apparatus of claim 11, wherein the receiver is supported to engage a portion of the exterior section of the tumble drum that is angularly offset from the lowermost portion of the exterior section by between one and 20 degrees in the direction of rotation of the exterior section of the tumble drum as the tumble drum rotates about its axis.

13. A tumble drum for use in processing food portions, comprising:
an inlet at a first end;
an outlet at a second end opposite the first end;
an interior mixing chamber intermediate the first end and the second end, the interior mixing chamber surrounded by a wall having an exterior section;
an axis extending through the inlet, the interior mixing chamber and the outlet about which the tumble drum can rotate;
an anterior wall at the first end of the tumble drum surrounding the inlet; and
a circumferential cavity proximal to the wall and surrounding the interior mixing chamber, the cavity having a first set of circumferentially distributed apertures through which the cavity is in fluid communication with the interior mixing chamber, the cavity further being in fluid communication with a second set of circumferentially distributed apertures in the exterior section of the wall of the tumble drum;
wherein a receiver coupled to a suction source can be engaged with the exterior portion to draw air laden with airborne flavoring material from the interior mixing chamber, through the first set of apertures, into the cavity, and through the second set of apertures to the receiver.

14. The tumble drum of claim 13, wherein the receiver is engaged proximal to a lowermost portion of the exterior portion of the tumble drum; and
wherein the air drawn from the interior mixing chamber is directed downwardly through food portions moving within the tumble drum as it rotates to deposit at least some of the airborne flavoring material onto the food portions as it is drawn from the interior mixing chamber through the first set of apertures.

15. The tumble drum of claim 13, further comprising:
a plurality of angularly spaced dividers disposed within the cavity to impair circumferential movement of air drawn into the cavity from the interior mixing chamber.

16. The tumble drum of claim 15, wherein each of the plurality of angularly spaced dividers are angularly separated from an adjacent divider by between 20 and 60 degrees.

17. The tumble drum of claim 13, wherein the exterior section comprises one of a radially recessed circumferential channel in an exterior portion of the tumble drum and a radially protruding circumferential rail in the exterior portion of the tumble drum.

18. The tumble drum of claim 13, wherein the exterior section comprises one of an axially inwardly recessed channel in the anterior wall of the tumble drum and an axially outwardly protruding rail in the anterior wall of the tumble drum.

19. A method of applying an airborne flavoring material to a plurality of food portions, comprising:
providing a tumble drum having an inlet at a first end, an outlet at a second end opposite the first end, an interior mixing chamber intermediate the first end and the second end, the interior mixing chamber surrounded by a wall having an exterior section, an axis extending through the inlet, the interior mixing chamber and the outlet about which the tumble drum can rotate, an anterior wall at the first end of the tumble drum surrounding the inlet and a circumferential cavity proximal to the wall and surrounding the interior mixing chamber, the cavity having a first set of circumferentially distributed apertures through which the cavity is in fluid communication with the interior mixing chamber, the cavity further being in fluid communication with a second set of circumferentially distributed apertures in the exterior section of the wall of the tumble drum;
providing a receiver having an outlet coupled to an air mover and an inlet adapted for engagement with at least a portion of the exterior section of the tumble drum as the tumble drum rotates about the axis, the receiver disposed proximal a lowermost portion of the exterior section of the tumble drum;
rotating the tumble drum about the axis while dispensing a flavoring material onto food portions moving within the tumble drum interior mixing chamber; and
operating the air mover to draw air laden with airborne flavoring material downwardly towards the lowermost portion of the tumble drum, through the food portions accumulated within the interior mixing chamber, through the first set of apertures, into the cavity, through the second set of apertures, into the inlet of the receiver and through the outlet of the receiver.

20. The method of claim 19, further comprising:
providing a filter housing having an inlet and an outlet;
providing a filter media within the filter housing;
fluidically coupling the inlet of the filter housing to the outlet of the receiver; and
fluidically coupling the outlet of the filter housing to the air mover;
wherein the air drawn from the interior mixing chamber can be filtered through the filter media to remove residual airborne flavoring material.
